(19) United States
(12) Patent Application Publication
(10) Pub. No.: US 2017/0270275 A1
(43) Pub. Date: Sep. 21, 2017

(54) Mobile Pharmacy

(71) Applicant: Vidya Nair, Tacoma, WA (US)

(72) Inventor: Vidya Nair, Tacoma, WA (US)

(21) Appl. No.: 15/076,365

(22) Filed: Mar. 21, 2016

(51) Int. Cl. G06F 19/00

(52) U.S. Cl. CPC G06F 19/3462

(57) ABSTRACT

A mobile pharmacy may provide services for a group of people who have similar medical considerations. For example, a group intending to visit another country may require certain vaccinations or medications. For another example, a group of people working at a common employer may have medical requirements related to a chronic disease. A mobile pharmacy may allow a pharmacist to prepare a prescription under an approved Collaborative Drug Therapy Protocol, followed by preparation of medications and vaccines specific to each clients. Vaccines and medications may be delivered and administered to clients at a convenient site by a pharmacist.

### FIELD

This disclosure generally relates to a mobile pharmacy.

### BACKGROUND

Prior to traveling to foreign countries, people sometimes want or need travel related vaccines and medications. Going to a clinic followed by a visit to pharmacy requires a person to allocate time for visit a clinician to receive vaccination and trip related counseling followed by a visit to pharmacist to configure travel related medication and associated counseling.

This two-step process requiring individuals to go to clinics followed by a visit to pharmacy to pick up medications may be of great inconvenience to patients.

### SUMMARY

A mobile pharmacy may include a variety of services that may provide a convenient way for a person or group of persons to get the vaccinations or medications they may need. A mobile pharmacy may not be meant to replace diagnostic services or higher levels of care provided by clinicians at hospitals or clinics; rather it may be used for delivery and administration of vaccinations and medications at a location convenient for an individual or groups of persons.

A mobile pharmacy may provide services for a group of people who have similar medical considerations. For example, a group intending to visit another country may require certain vaccinations or medications. For another example, a group of people working at a common employer may have medical requirements related to a chronic disease. A mobile pharmacy may allow a pharmacist to prepare a prescription under an approved Collaborative Drug Therapy Protocol, followed by preparation of medications and vaccines specific to each clients. Vaccines and medications may be delivered and administered to clients at a convenient site by a pharmacist.

This may be useful, for example, for a group planning a trip to receive necessary vaccinations or other medications without requiring multiple trips to clinics and pharmacies.

### BRIEF DESCRIPTION OF THE DRAWINGS

FIG. 1 is a flow chart for a mobile pharmacy, according to one embodiment.

FIG. 2 is a block diagram of a medical information form, according to one embodiment.

FIG. 3 illustrates packages, according to one embodiment.

FIG. 4 illustrates an example of a computer system and network that may support a mobile pharmacy, according to one embodiment.

FIG. 5 illustrates a component diagram of a computing device, according to one embodiment.

Like reference numerals are used to designate like parts in the accompanying drawings.

### DETAILED DESCRIPTION

A more particular description of certain embodiments of Mobile Pharmacy may be had by references to the embodiments shown in the drawings that form a part of this specification, in which like numerals represent like objects.

The instant application discloses, among other things, a mobile pharmacy. A mobile pharmacy may allow a pharmacist to prescribe and prepare a package of medical or other supplies for a patient. A pharmacist is a person authorized by a state to prescribe, dispense, and administer drugs. A patient may transmit personal medical information to a pharmacist by paper forms, digital forms, such as a website, or a phone call, for example. Based on this information, the pharmacist may prepare and package one or more medications or vaccinations for the patient.

The medical supplies and or vaccines that are prepackaged may be transported by a pharmacist to a designated location to meet with one or more patients. The pharmacist may then dispense or administer the transported prepackaged medical supplies or vaccines to the patients. This may be useful, for example, for a group planning a trip to receive necessary vaccinations or other medications without requiring multiple trips to clinics and pharmacies. It may also be useful for a group meeting for help with chronic diseases, such as a diabetic support group.

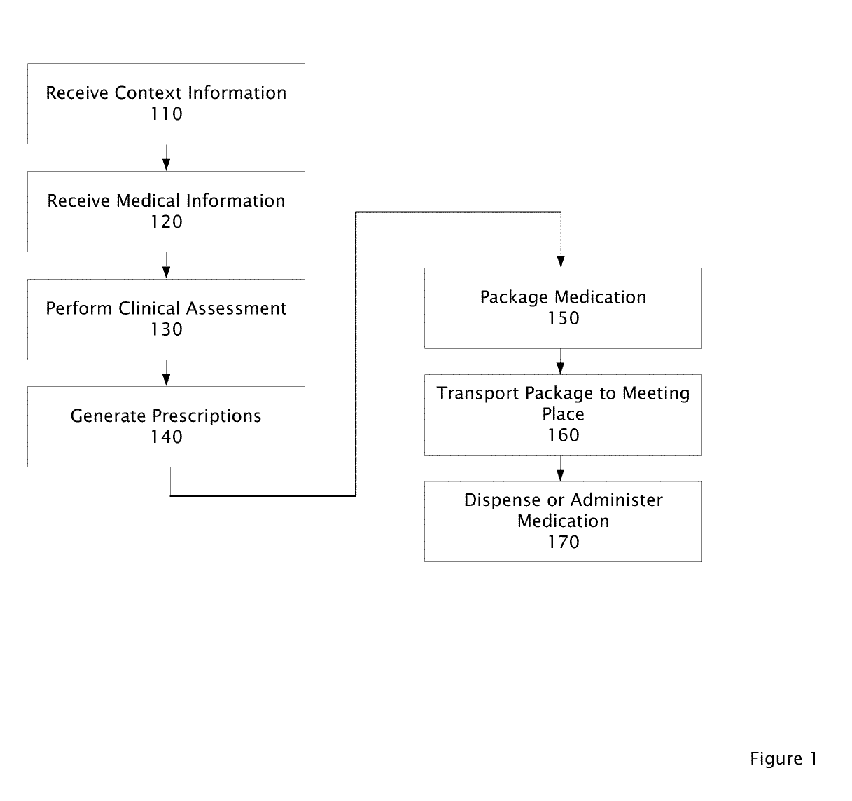

FIG. 1 is a flow chart of Mobile Pharmacy, according to one embodiment. A pharmacist may Receive Context Information 110 about a group or an individual. For example, the pharmacist may receive information about a group for managing a chronic disease, or for a group planning a trip. The pharmacist may also receive information from patients in the group about each patient's specific issues related to the group context, and may Receive Medical Information 120 from each patient. The pharmacist may Perform Clinical Assessment 130 to determine appropriate vaccines and medications for each patient. For example, if a client is planning a trip to India, is generally healthy, and is up-to-date on standard vaccinations in the US, the pharmacist may determine that it would be appropriate for the client to receive immunizations for Hepatitis A, Hepatitis B, typhoid fever, Japanese encephalitis, rabies, and yellow fever for the trip. Another patient may require a different mix of immunizations or medications prior to the trip. The pharmacist may Generate Prescriptions 140 for each patient based on the context information and medical information received.

The pharmacist may then Package Medication 130, pulling the required materials from stock or obtaining it from other sources, as necessary. Each medication or vaccine may be labeled as required by a state board which can authorize pharmacists. The pharmacist may place Vaccines 310 and Medications 320 for the client in a Package 300 associated with that client, so that if the pharmacist is preparing vaccines and medications for a number of clients, a package may be used for each client. The pharmacist may then Transport Package to Meeting Place 140. For example, if a company is sending a group of employees to India, the company may provide a location to allow the group to obtain their treatments without requiring each of them to arrange for it on their own. This may improve efficiency and reduce time lost from work. For example, if the pharmacist wishes to provide some general health warnings about the area to which travel is planned, a general presentation or talk may be given to all clients at once. Each client may them go to a private area, where the pharmacist may dispense or administer the appropriate medication or vaccinations to each person.

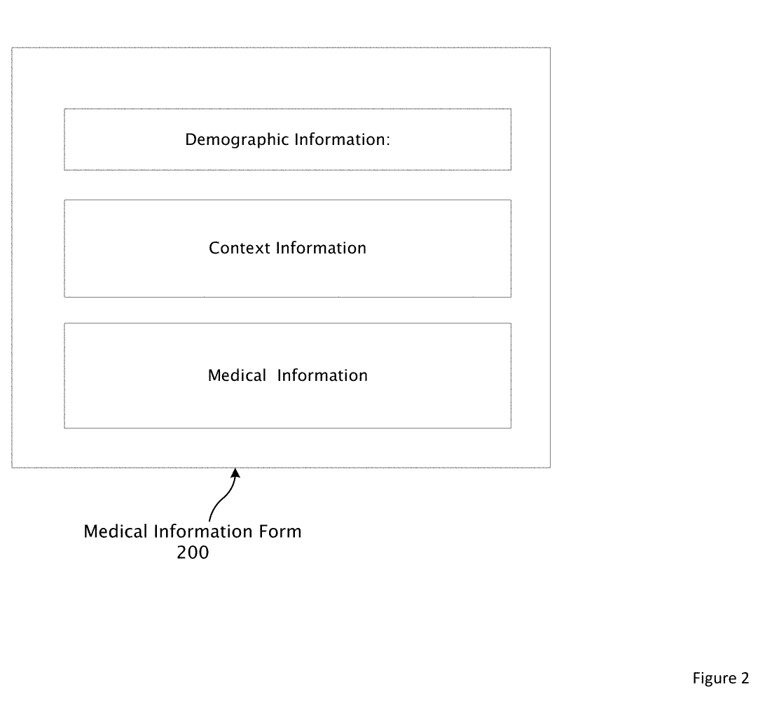

FIG. 2 is a block diagram of a Medical Information Form 200 that may, for example, be completed on paper or on a computer. Medical Information Form 200 may be used to obtain relevant information from a client to allow a pharmacist to determine appropriate medical preparations in planning a trip or for managing a chronic disease.

Medical Information Form 200 may collect such information as the client's name, address, date of birth, and other demographic information. Medical Information Form 200 may also collect where and when the client is planning to travel, what chronic diseases a client may have, or other context information. Medical Information Form 200 may also collect medical information about the client, including, for example, allergies, medications being taken, medical history, or other medical information.

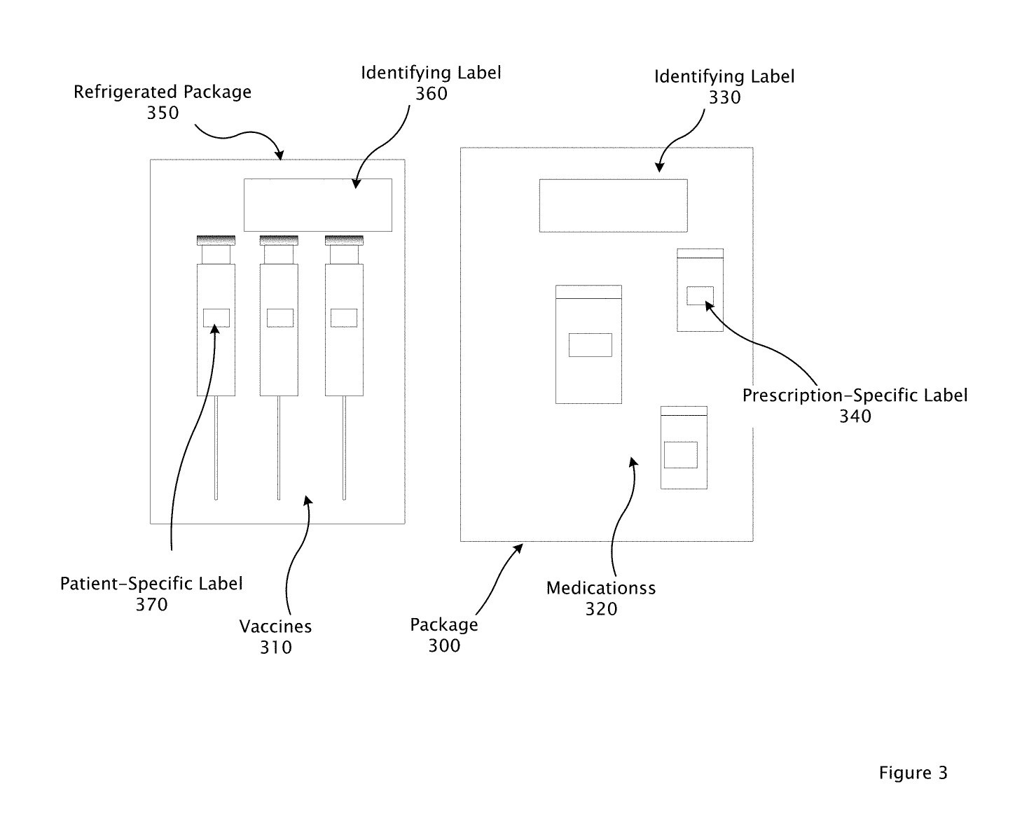

FIG. 3 illustrates packages for transporting vaccines or medications, according to one embodiment. Package 300 may contain Medications 320 for an individual client. The client may be identified on Identifying Label 330. Each Medication 320 may also be labeled with Prescription-Specific Labels 340 in compliance with state regulations.

Refrigerated Package 350 may be used to transport Vaccines 310 or other medication requiring refrigeration. The client may be identified on Identifying Label 360. Each Vaccine 310 may also be labeled with Prescription-Specific Labels 370 in compliance with state regulations.

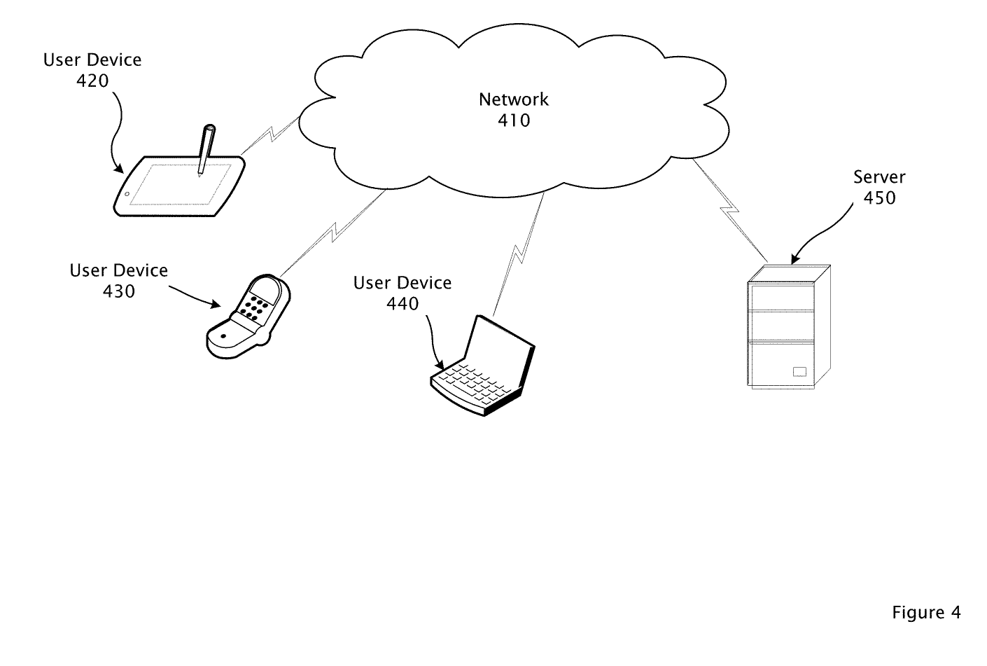

FIG. 4 illustrates an example of a computer system and network that may support a mobile pharmacy, according to one embodiment.

Clients may use User Device 420, 430, 440 to enter medical information, using Medical Information Form 200, for example. Clients may also use User Device 420, 440, 440 to arrange appointments, ask questions, or have other interactions with a pharmacist, for example.

One or more User Device 420, 430, 440 may be coupled to each other, a server, or to other devices via Network 410. User Device 420, 430, 440 may include a desktop computer, laptop computer, smartphone, tablet, or wearable devices such as a smartwatch, activity tracker, or intelligent eyewear, for example.

Network 410 may include Wi-Fi, cellular data access methods, such as 3G or 4GLTE, Bluetooth, NFC, the internet, local area networks, wide area networks, or any combination of these or other means of providing data transfer capabilities. In one embodiment, Network 410 may comprise Ethernet connectivity. In another embodiment, Network 410 may comprise fiber optic connections.

Server 450 may include one or more computers, and may serve several roles. Server 450 may be conventionally constructed, or may be of a special purpose design for Input Processing. One skilled in the art will recognize that Server 450 may be of many different designs and may have different capabilities. Server 450 may host applications, data, or other information supporting Input Processing.

User Device 420, 430, or 440 may be used to access information or programs on Server 450. Server 450 may, for example, receive a Medical Information Form 200 from User Device 420, and may upload data from the form to Server 450. In another embodiment, Server 450 may not be used, and data from Medical Information Form 200 may be sent to User Device 440, which may be used by the pharmacist. In another embodiment, a pharmacist may use Network 410 and connected equipment to notify groups of clients of information of interest to them. For example, if a country a group is intending to visit has an outbreak of a disease, the pharmacist may notify the group that additional immunizations are recommended. One having skill in the art will recognize that many different configurations may be used by clients and pharmacists to communicate information about Mobile Pharmacy.

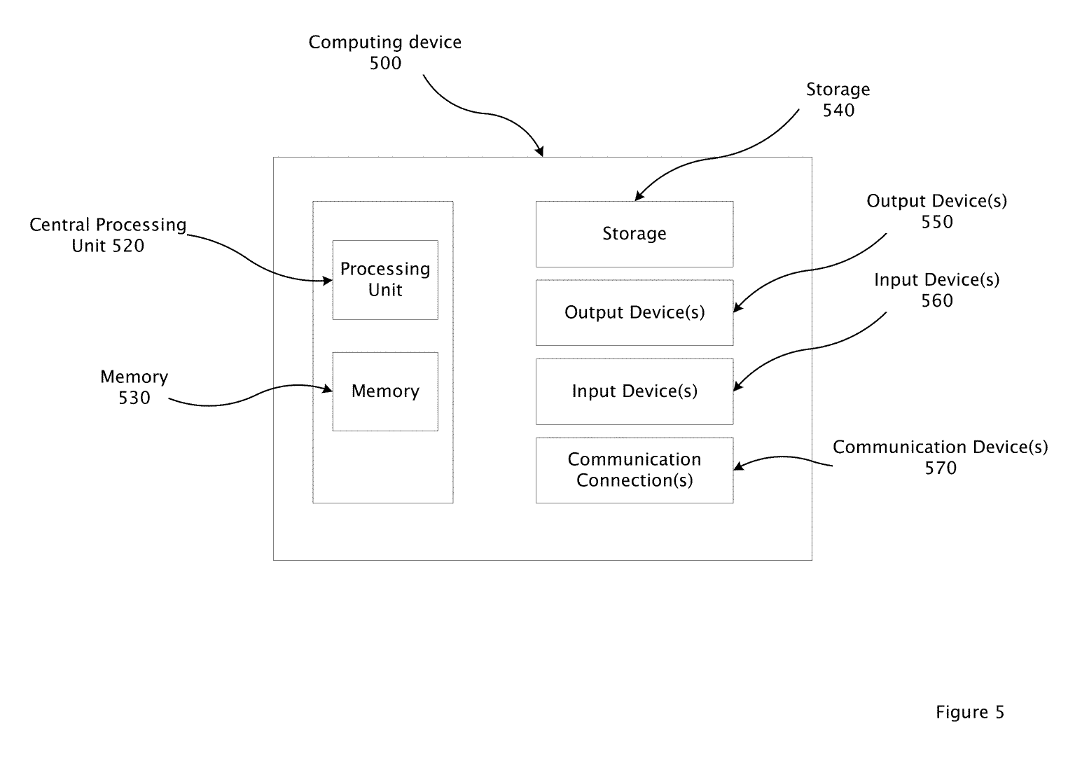

FIG. 5 illustrates a component diagram of Computing Device 500, which may support Mobile Pharmacy, according to one embodiment. Computing Device 500 can be utilized to implement one or more computing devices, computer processes, or software modules described herein, including, for example, but not limited to a device, such as User Device 420, 430, or 450 or a server, for example, Server 450. In one example, Computing Device 500 can be used to process calculations, execute instructions, and receive and transmit digital signals. In another example, Computing Device 500 can be utilized to process calculations, execute instructions, receive and transmit digital signals, receive and transmit search queries and hypertext, and compile computer code suitable for a mobile device. Computing Device 500 can be any general or special purpose computer now known or to become known capable of performing the steps and/or performing the functions described herein, either in software, hardware, firmware, or a combination thereof.

In its most basic configuration, Computing Device 500 typically includes at least one Central Processing Unit (CPU) 520 and Memory 530. Depending on the exact configuration and type of Computing Device 500, Memory 530 may be volatile (such as RAM), non-volatile (such as ROM, flash memory, etc.) or some combination of the two. Computing Device 500 may also have additional features/functionality. For example, Computing Device 500 may include multiple CPUs. The described methods may be executed in any manner by any processing unit in Computing Device 500. For example, the described process may be executed by both multiple CPUs in parallel.

Computing Device 500 may also include additional storage (removable and/or non-removable) including, but not limited to, magnetic or optical disks or tape. Such additional storage is illustrated in FIG. 5 by Storage 540. Computer readable storage media include volatile and nonvolatile, removable and non-removable media implemented in any method or technology for storage of information such as computer-readable instructions, data structures, program modules or other data. Memory 530 and Storage 540 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 500. Any such computer-readable storage media may be part of Computing Device 500. Computer readable storage media do not include transient signals.

Computing Device 500 may also contain Communication Device(s) 570 that allows the device to communicate with other devices. Communication Device(s) 570 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 500 may also have Input Device(s) 560 such as keyboard, mouse, pen, voice input device, touch input device, etc. Output Device(s) 550 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A method performed by a pharmacist, comprising:
receiving, from a plurality of clients, context information;
receiving from each of the clients medical information;
assessing the context information and medical information for each client;
prescribing appropriate vaccines or medications for each client;
dispensing the prescribed vaccines or medications, the dispensing including labeling each vaccine or medication as proscribed by state law;
packaging the vaccines and medication for each client in a package associated with the client;
transporting a plurality of the separate packages to a meeting place;
providing medical information about the context to the plurality of patients; and
privately dispensing or administering the vaccines and medication in each package to the client associated with the package.

2. The method of claim 1, wherein the context information concerns a trip.

3. The method of claim 1, wherein the context information concerns a chronic issue.

4. The method of claim 1, wherein the trip information or the medical information for at least one client is received by a telephone call.

5. The method of claim 1, wherein the trip information or the medical information for at least one client is received on a computing device.

6. The method of claim 1, wherein the trip information or the medical information for at least one client is received on paper.
